(19) United States
(12) Patent Application Publication
(10) Pub. No.: US 2014/0327687 A1
(43) Pub. Date: Nov. 6, 2014

(54) IMAGE GENERATING APPARATUS AND METHOD FOR CONTROLLING THE SAME

(71) Applicant: CANON KABUSHIKI KAISHA, Tokyo (JP)

(72) Inventor: Tomochika Murakami, Ichikawa-shi (JP)

(21) Appl. No.: 14/363,831

(22) PCT Filed: Feb. 5, 2013
(86) PCT No.: PCT/JP2013/000610

§ 371 Date: Jun. 9, 2014

(30) Foreign Application Priority Data
Feb. 16, 2012 (JP) 2012-031671

(51) Int. Cl. G06T 1/60

(52) U.S. Cl. CPC G06T 1/60; G06T 2200/28; G09G 2340/02; G09G 2340/045; G09G 2350/00
USPC 345/545

(57) ABSTRACT

Operations by the user include a first change operation to move a display target area in a horizontal direction, a second change operation to move a display target area in a depth direction, and a third change operation to change the display magnification. In an image generating apparatus, data to be required for updating the display target image data in case of a change operation is predicted for each of the plurality of change operations, and the predicted data for each change operation is stored in the memory area. An allocation of data volume that can be stored in the memory area to each change operation is adaptively changed depending on the current display magnification, user setting mode, annotation information, operation history, user information, type of staining or the like.

### TECHNICAL FIELD

The present invention relates to an image generating apparatus that generates display target image data from original image data, and a method for controlling the same.

### BACKGROUND ART

In the pathology field, a virtual slide system, which images a test sample placed on a slide and digitizes the image so as to perform pathological diagnosis on the display, is used as an alternative to an optical microscope which is a tool of pathological diagnosis. Since the virtual slide system digitizes a pathological diagnostic image, conventional optical microscopic image of a test sample can be handled as digital data. The merits of the virtual slide system include quickening remote diagnosis, explanation to a patient using digital images, sharing rare cases, and making education and practice efficient.

In order to virtualize the operation of the optical microscope using a virtual slide system, the whole image of the test sample on the slide must be digitized. By digitizing the whole image of the test sample, the digital data created by the virtual slide system can be observed using viewer software which runs on a PC or workstation. The number of pixels generated by digitizing the whole image of the test sample is normally several hundred million to several billion pixels, which is an enormous data volume.

Although the volume of data created by the virtual slide system is enormous, the viewer can allow observation by performing zoom in or zoom out of the image, from micro (enlarged detailed image) to macro (bird's eye image), and provide various conveniences to the user. If all the necessary information is acquired in advance, an image can be immediately displayed at a resolution and magnification desired by the user, from a low magnification image to a high magnification image.

A sample in a slide has a thickness, in which a depth position where a target tissue or cells to be observed exist differs depending on the (horizontal) observation position of the slide. Therefore a plurality of images are captured with changing the focal position along the optical axis direction. (In this description, a plurality of image data acquired by imaging a sample with changing the focal position along the optical axis direction is called “Z stack image”, and two-dimensional image data at each focal position, constituting the Z stack image, is called a “layer image”.)

In pathological diagnosis, a pathologist skillfully uses an optical microscope to change magnification, move a stage, and focus on an image at high-speed, and observe the entire slide and check details. However the display speed of high definition large capacity image data captured by the virtual slide system is not fast enough for the observation speed of a pathologist, which is one of the problems when promoting the digitization of pathological diagnosis based on images. Therefore a viewer used for a virtual slide system is demanded to have better display responsiveness to user operation, such as changing horizontal (XY) directions of a display area, changing the depth (Z) direction of a display area, and changing display magnification (M).

The following high-speed display techniques for the hierarchical image data constituted by image data with different resolutions have been proposed. In Patent Literature (PTL) 1, data on an image area which has high possibility to be displayed is loaded to the main memory in a compressed state, from the compressed image data separated into predetermined-sized blocks. Then out of the loaded compressed image data, image data on an area, which is required or expected to be required for display, is decoded (compressed encoding of the image is decompressed), and the decoded data is stored in a buffer memory which can be accessed at high-speed. By this configuration, response speed to update the display image is increased.

### CITATION LIST

### Patent Literature

[PTL 1]
Japanese Patent Application Laid-Open No. 2010-87904

### SUMMARY OF INVENTION

### Technical Problem

In the above mentioned prior art, however, the following problems exist.

As an example of a pre-read processing, PTL 1 discloses a prediction based on the display history. However a display history does not exist for an area which is observed for the first time (non-displayed area), therefore an effective pre-read cannot be implemented, and the response speed to update the image cannot be improved. PTL 1 also discloses a prediction based on the image content, as another example of the pre-read processing. In this prediction, however, display and image analysis are performed simultaneously, which means that load is high, and improving the response speed is difficult.

As an image block to be loaded to the main memory, PTL 1 discloses a rule to assign priority to an image block in a different hierarchy than an image block in a same hierarchy as the display image, that is an image block of an enlarged image or a reduced image. This is because all the decoded memories must be updated if hierarchy is shifted, which must be avoided. But if this rule is applied, when the user shifts the display areas within a same hierarchy most of the time, or when the display area is markedly shifted within a same hierarchy, the buffer does not function effectively, and response speed drops.

Generally it is difficult to accurately predict what kind of operation the user of the image viewer will instruct next. Prediction becomes more difficult as the flexibility of changing the display of the image viewer increases, such as a case of moving in the horizontal (XY) directions, moving in the depth (Z) direction, and changing the magnification (M). However it is impractical to provide a buffer memory that can cover all possible change operations, since a memory that can be accessed at high-speed is expensive, and the capacity of the buffer memory has physical and logical restrictions. Therefore a technique to effectively use a buffer memory having a limited capacity is demanded.

With the foregoing in view, it is an object of the present invention to provide a technique to improve the utilization efficiency of a buffer memory, and comprehensively improve the response speed to change a display when the user operation is received.

### Solution to Problem

The present invention in its first aspect provides an image generating apparatus that generates display target image data from original image data for a viewer having a function to display an image corresponding to a portion of the original image data and change the displayed portion according to an operation by a user, comprising:

a first storage unit that stores the original image data;

a second storage unit that can temporarily store a portion of the original image data, wherein a data reading speed of the second storage unit is faster than that of the first storage unit;

a generation unit that generates the display target image data from the original image data according to the operation by the user, and when data required for generating the display target image data is stored in the second storage unit, uses the data stored in the second storage unit; and

a control unit that predicts data to be used by the generation unit, and controls which portion of the original image data is to be stored in the second storage unit, wherein

the operation by the user includes a plurality of change operations including a first change operation to move a display target area in a horizontal direction and at least one of a second change operation to move the display target area in a depth direction and a third change operation to change a display magnification,

the control unit predicts data to be required for updating the display target image data in case of each of the plurality of change operations, and stores the predicted data for each change operation in the second storage, and

an allocation of data volume that can be stored in the second storage unit to each change operation can be changed.

The present invention in its second aspect provides a method for controlling an image generating apparatus that includes:

a first storage unit that stores original image data;

a second storage unit that can temporarily store a portion of the original image data, wherein a data reading speed of the second storage unit is faster than that of the first storage unit; and

a generation unit that generates display target image data from the original image data for a viewer having a function to display an image corresponding to a portion of the original image data and change the displayed portion according to an operation by a user, and when data required for generating the display target image data is stored in the second storage unit, uses the data stored in the second storage unit, wherein

the operation by the user includes a plurality of change operations including a first change operation to move a display target area in a horizontal direction and at least one of a second change operation to move the display target area in a depth direction and a third change operation to change a display magnification,

the method for controlling an image generating apparatus comprising the steps of:

changing an allocation of data volume that can be stored in the second storage unit to each change operation, according to information acquired from the viewer or the original image data; and

predicting data to be required for updating the display target image data in case of each of the plurality of change operations, and storing the predicted data for each change operation in the second storage unit according to the allocation.

The present invention in its third aspect provides a program or a computer readable medium storing the program for an image generating apparatus that includes:

a first storage unit that stores original image data;

a second storage unit that can temporarily store a portion of the original image data, wherein a data reading speed of the second storage unit is faster than that of the first storage unit; and

a generation unit that generates display target image data from the original image data for a viewer having a function to display an image corresponding to a portion of the original image data and change the displayed portion according to an operation by a user, and when data required for generating the display target image data is stored in the second storage unit, uses the data stored in the second storage unit, wherein

the operation by the user includes a plurality of change operations including a first change operation to move a display target area in a horizontal direction and at least one of a second change operation to move the display target area in a depth direction and a third change operation to change a display magnification,

the program allowing the image generating apparatus to execute the steps of:

changing an allocation of data volume that can be stored in the second storage unit to each change operation, according to information acquired from the viewer or the original image data; and

predicting data to be required for updating the display target image data in case of each of the plurality of change operations, and storing the predicted data for each change operation in the second storage unit according to the allocation.

### Advantageous Effects of Invention

According to the present invention, the utilization efficiency of a buffer memory can be improved, and the response speed to change the display when the user' operation is received can be comprehensively improved.

Further features of the present invention will become apparent from the following description of exemplary embodiments with reference to the attached drawings.

### BRIEF DESCRIPTION OF DRAWINGS

FIG. 1 is a diagram depicting a configuration of an image display system.

FIG. 2 is a schematic diagram depicting a display example of an image viewer.

FIG. 3 is a diagram depicting an internal configuration of an image generating apparatus.

FIG. 4 is a diagram depicting a slide, which is an object.

FIG. 5 is a diagram depicting a state of slide imaging.

FIG. 6 is a schematic diagram depicting a data structure of hierarchical image data according to Embodiment 1.

FIG. 7 is a functional block diagram for implementing a display update and a data pre-read according to user' operation.

FIG. 8 is a schematic diagram for explaining storage location and structure of input/output image data of each unit in FIG. 7.

FIG. 9 is a flow chart depicting internal processing of the pre-read area calculation unit according to Embodiment 1.

FIG. 10 is a schematic diagram for explaining a result of area group classification.

FIGS. 11A and 11B are schematic diagrams depicting a pre-read area of a depth area group according to Embodiment 1.

FIG. 12 is a schematic diagram depicting a data structure of hierarchical image data according to Embodiment 7.

FIG. 13 is a schematic diagram depicting a data structure of hierarchical image data according to Embodiment 8.

### DESCRIPTION OF EMBODIMENTS

### Embodiment 1

(General Configuration)

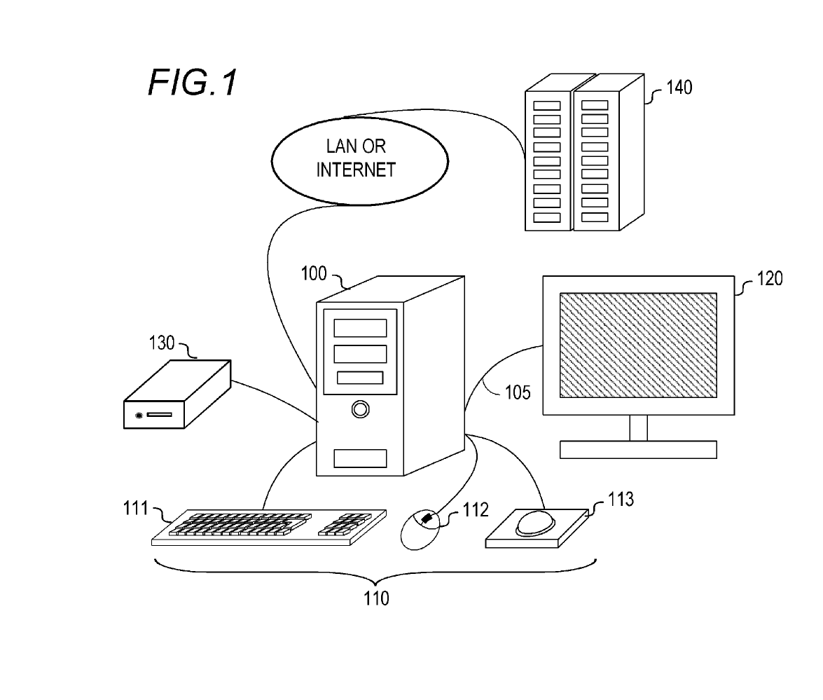

FIG. 1 shows a configuration of an image display system according to an embodiment of the present invention.

An input operation device 110 for accepting input from the user, and a display (display device) 120 for displaying an image processed by an image generating apparatus (host computer) 100 to the user are connected to the image generating apparatus 100. Examples of the input operation device 110 are a keyboard 111, a mouse 112 and a dedicated controller 113 (e.g. trackball) for improving operability for the user. A storage device 130, such as a hard disk drive, an optical drive and a flash memory, and other computer systems 140 that can be accessed via a network I/F are also connected to the image generating apparatus 100. The storage device 130 exists outside the image generating apparatus 100 in FIG. 1, but may be enclosed in the image generating apparatus 100.

The image generating apparatus 100 acquires image data from the storage device 130 according to the control signal which the user inputted via the input operation device 110, and generates and updates the image data for display to be displayed (display target image data).

An image display application (image viewer) is a computer program executed by the image generating apparatus 100. This program is stored in an internal storage device (not illustrated) in the image generating apparatus 100, or in the storage device 130. The display target image data, that is generated by the image generating apparatus 100, is displayed on the screen of the display 120 by the image display application (image viewer), and is presented to the user.

(Display Screen)

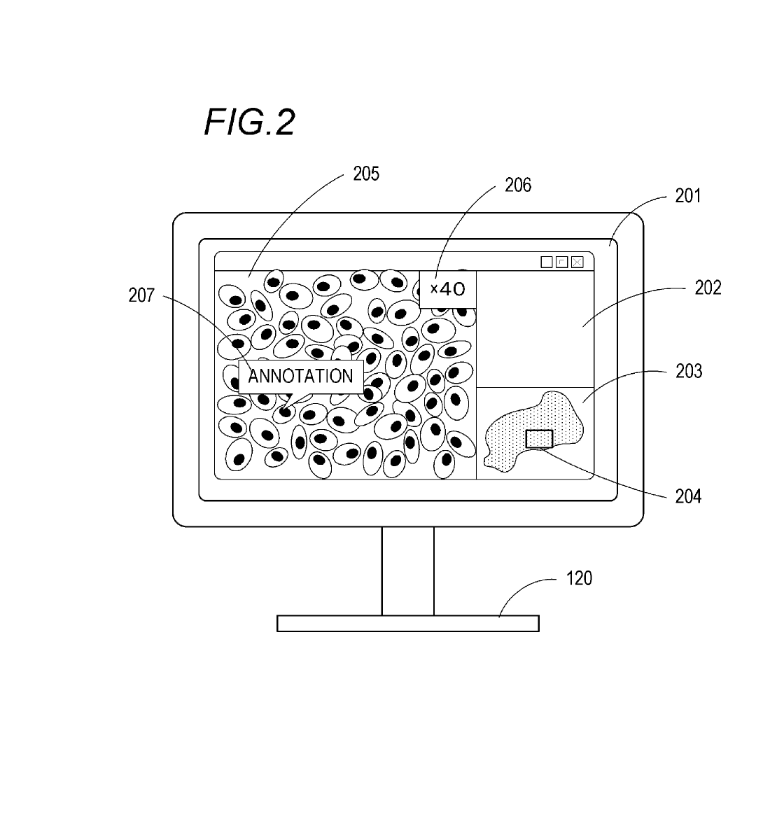

FIG. 2 shows an example of display target image data which is generated by the image generating apparatus 100, and is displayed on the display 120 via the image display application.

FIG. 2 shows a basic configuration of a screen layout of the image display application. The display screen has a general window 201 in which an information area 202 which shows a state of display and operation and various information on the image, a thumbnail image 203 which shows the whole observation target (specimen), a display image 205 for detailed observation, and a display magnification 206 of the display area 205 are arranged. In the thumbnail image 203, a frame 204 is displayed to indicate an area currently in-display in the display area 205 for detailed observation. Thereby the user can know the position and size of the portion in the entire specimen, that correspond to the image of which details are currently observed in the display area 205.

Using the input operation device 110, the user can instruct various change operations, such as moving the area to be displayed (display target area) in the display area 205 for detailed observation in the horizontal (XY) directions, increasing/decreasing the display magnification (M), and moving the display target area in the depth (Z) direction. For the operation to change the image displayed in the display area 205, rotating the image, changing the depth of field (focus stacking) or the like may also be provided. The user can attach annotation information (comment information) 207 in an arbitrary position of the image currently displayed in the display area 205, using the input operation device 110.

The movement in the depth (Z) direction refers to switching to a layer image at a different focal position in the case of a Z stack image. In the case of three-dimensional image data (e.g. voxel data) acquired by other means, moving in the depth (Z) direction corresponds to an operation to move the slicing position.

The movement in the horizontal direction can be instructed by dragging an image in the display area 205 or the frame 204 in the thumbnail image 203 using the mouse 112. Zoom in/zoom out of an image can be implemented by rotating the mouse wheel (e.g. forward rotation of wheel to zoom in, backward rotation to zoom out), for example. The movement in the depth direction can be implemented by rotating the mouse wheel while pressing a predetermined key (e.g. Ctrl key) (e.g. forward rotation of wheel moves an image of which depth is deep, and backward rotation moves an image of which depth is shallow, for example).

As the user performs operations to change the display image as mentioned above, the display area 205, the display magnification 206, and the frame 204 in the thumbnail image 203 are updated. Thus the user can observe an image in a horizontal direction, in a depth direction and at a magnification exactly as desired.

(Image Generating Apparatus)

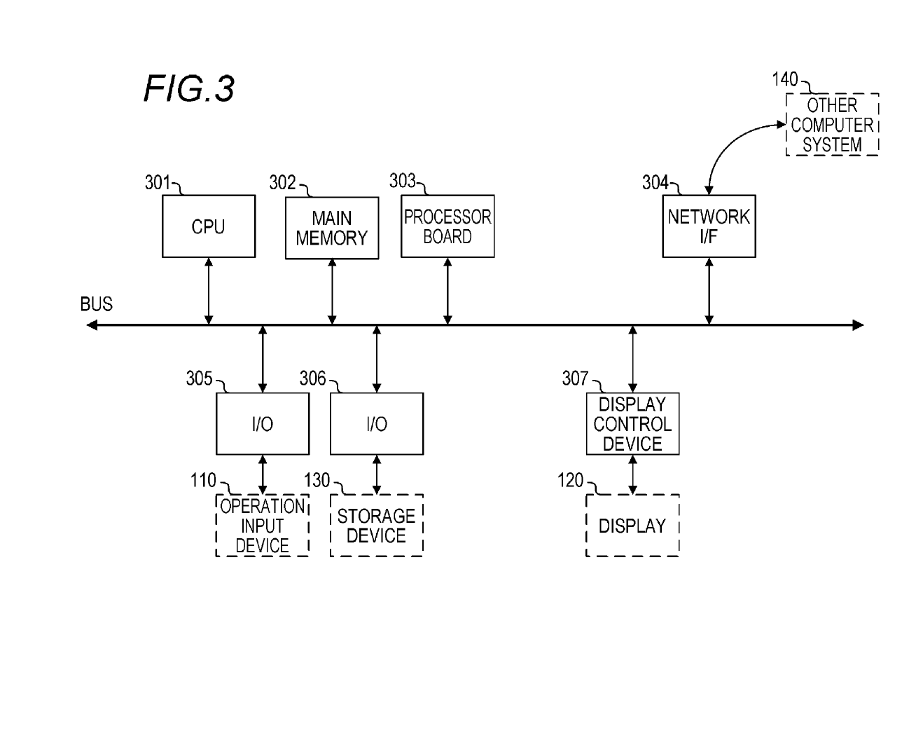

FIG. 3 is a diagram depicting an internal hardware configuration of the image generating apparatus 100.

A CPU 301 controls the image generating apparatus in general, using programs and data stored in a main memory 302. The CPU 301 also performs various types of arithmetic processing and data processing to be described in the embodiments hereinbelow, such as decoding encoded compressed data, zoom in/zoom out and rotation of an image, execution of image viewer, update of display image and pre-read (buffering) of data.

The main memory 302 has an area for temporarily storing programs and data loaded from the storage device 130, and programs and data downloaded from other computer systems 140 via a network I/F (interface) 304. The main memory 302 also has a work area required by the CPU 301 to execute various types of processing.

The input operation device 110 is constituted by devices that can input various instructions to the CPU 301, such as the keyboard 102, the mouse 103 and the dedicated controller 113. The user inputs information for controlling the operation of the image generation apparatus 100 via the input operation device 110. 305 is an I/O for notifying the CPU 301 of various instructions inputted via the input operation device 110. The storage device 130 is a large capacity data storage device, such as a hard disk drive (HDD) or a solid state drive (SSD), and stores the OS (Operating System) and programs and image data required for the CPU 301 to execute the processing described in the following embodiments. Information is written to the storage device 130 or read from the storage device 130 via the I/O 306.

A display control device 307 performs control processing for displaying images and characters on the display 120. The display 120 displays a screen for prompting the user to input information, and displays image data that was acquired from the storage device 130 and other computer systems 140, and processed by the CPU 301.

A processor board 303 has a processor of which specific computing function, such as image processing function, is enhanced, and a buffer memory (not illustrated). In the embodiments described below, the CPU 301 is used for various types of arithmetic processing and data processing, and the main memory 302 is used as a memory area (buffer) which temporarily stores image data. The processor and the buffer memory on the processor board 303 may also be used, and this configuration is also in the scope of the present invention. The processing to read data in a high-speed memory in advance include “buffering” and “caching”, but in the present description, “buffering” and “caching” are regarded as having the same meaning.

(Object and Imaging Apparatus)

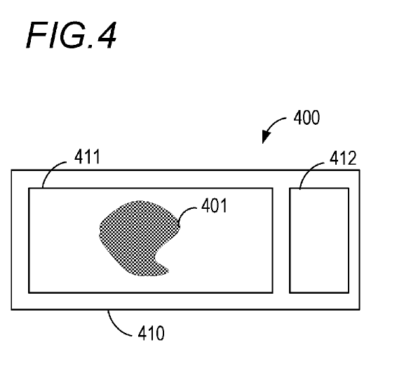

FIG. 4 shows a slide 400 of a pathological sample, which is an example of an object according to the present invention. In the slide 400 of the pathological sample, a specimen 401 placed on the slide glass 410 is sealed by a mounting agent (not illustrated) and a cover glass 411 that is placed thereon. The size and thickness of the specimen 401 differ depending on the specimen. A label area 412, where information on the specimen 401 is written, exists on the slide glass 410.

In the following embodiments, a slide of a pathological sample shown in FIG. 4 will be described as an example of an object. However an object is not limited to this slide. An object can be an object which has bumps on the surface, such as a metal surface, to be observed by a microscope, or a transparent bio-sample. The image is not limited to a microscope image, but may be an image of a living body or an object acquired by other imaging apparatuses, or may be a nature image captured by a digital camera, such as a landscape, or a portrait photograph.

(Imaging Apparatus)

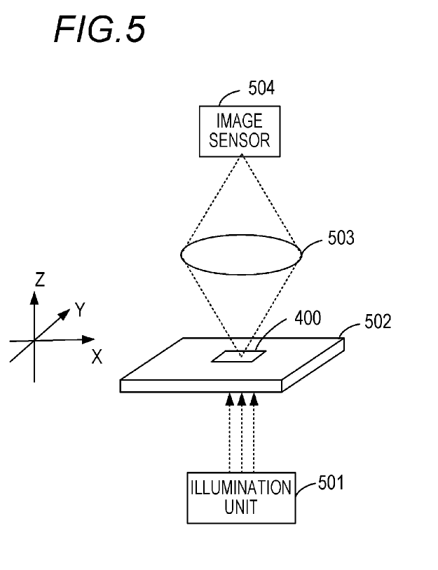

FIG. 5 shows a part of the configuration of an imaging apparatus that digitizes an object.

A slide 400 is placed on a stage 502, light is irradiated from an illumination unit 501, an image is formed on an image sensor 504 by an imaging optical system 503 including a replaceable objective lens, and the image on the image sensor 504 is digitized by photoelectric conversion. As FIG. 5 shows, the coordinates are set such that Z is the optical axis direction of the imaging optical system 503.

A plurality of image data at different magnifications can be acquired by executing imaging a plurality of times with changing the magnification of the imaging optical system 503. A plurality of image data at different focal positions (depth positions) can be acquired by executing imaging a plurality of times while moving the stage 502 in the Z direction at a predetermined pitch. If the entire object cannot be included in the angle of view by executing imaging only once, imaging is executed a plurality of times while moving the stage 502 in the X direction or Y direction or both X and Y directions, without changing the magnification and the depth direction, whereby a plurality of image data at different horizontal directions can be acquired.

The movement of the display area in the horizontal direction, the movement thereof in the depth direction, and the change of magnification in the image display application described above correspond to the movement of the stage 502 in the X and Y directions, the movement of the stage 502 in the Z direction, and the change of the magnification of the imaging optical system 503 respectively. The value of the display magnification 206 shown in FIG. 2 can be corresponded to the magnification of the imaging optical system 503 shown in FIG. 5.

(File Configuration)

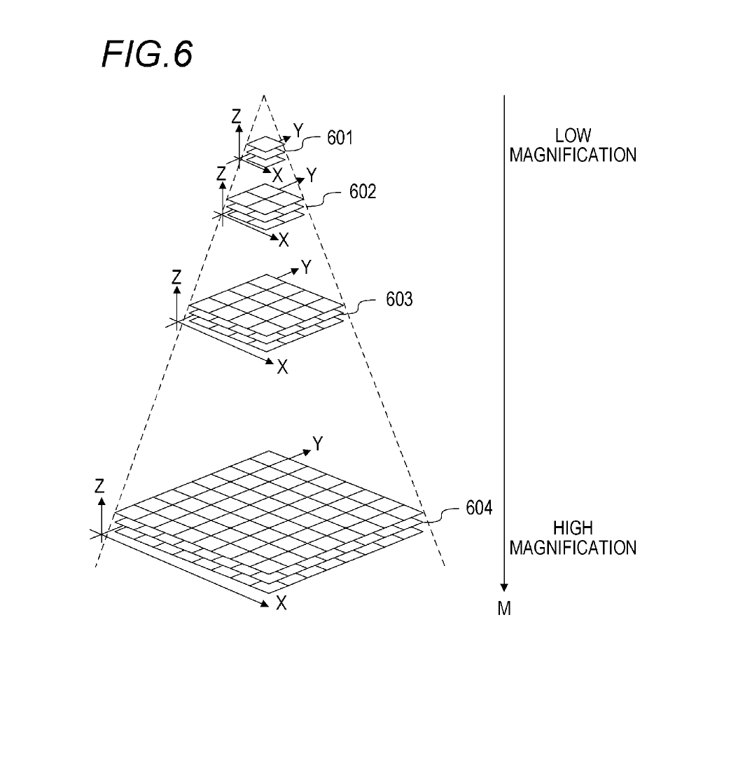

FIG. 6 is a schematic diagram depicting an example of a data structure of an image file created by imaging an object. As FIG. 6 shows, data on one object is hierarchical image data having a hierarchical structure, constituted by a plurality of two-dimensional image data of which horizontal (XY) positions, depth (Z) position and magnification (M) are different.

601 to 604 in FIG. 6 show image data groups imaged at magnifications of 5× (5 times), 10×, 20× and 40× respectively. The image data group 601 is constituted by three two-dimensional image data of which depth (Z) positions are different. This data group is acquired by executing imaging the object three times with changing the focal position in the depth (Z) direction at a predetermined pitch, and the image data group 601 is called a “Z stack image”, and each two-dimensional image data constituting the Z stack image is called a “layer image”. The other image data groups 602, 603 and 604 are also Z stack images constituted by three layer images respectively. In FIG. 6, there are four Z stack image sets captured at different magnifications, and each Z stack image is constituted by three layer images, but the number of Z stack images (the number of magnifications) and the number of layer images can be any value. For example, if a sample of an object has a 4 um (micrometer) thickness, and is imaged from the upper end of the sample at a 0.5 um pitch, then nine layer images are required to cover the entire thickness of the sample. If the pitch is 1.0 um, 2 um and 4 um, 5, 3 and 2 layer images are required respectively.

As FIG. 6 shows, the Z stack images 601 to 604 have different image sizes (the number of pixels in the X direction and in the Y direction) depending on the magnification. This is because the field of view is changed depending on the magnification when digital image data is displayed on a display device. For example, if a 20 mm×20 mm square area on the slide is imaged at an ×40 imaging optical system magnification and a 0.25 um/pixel sensor pixel pitch, the size of the image is 80000×80000 pixels. If the magnification for imaging is 20×, a double field of view is provided when the image is displayed, that is one side is set to be half of the case of 40× magnification, and the image size becomes 40000×40000 pixels. In the same manner, if the magnification for imaging is 10× or 5×, the image size becomes 20000×20000 pixels or 10000×10000 pixels respectively.

This hierarchical image data may be generated by actually imaging the object with changing the magnification and focal position of the imaging optical system 503. The object may actually be imaged only when the magnification of the image data is high, such as 40×, and the other data may be virtually generated by digital image processing. In this case, a Z stack image imaged at a low magnification by changing a focal position can be generated by performing processing to enlarge the depth of field on a Z stack image imaged at high magnification, and the image data at low magnification can be generated by reducing the image data at high magnification.

In the hierarchical image data shown in FIG. 6, the layer images constituting each of the Z stack images 602 to 604 are divided into a plurality of blocks. The size of a block, that is a sub-block size, may be any value, but as an example, a case of 256×256 pixels is described in this embodiment.

One block in the layer image indicates a range of 64 um (=0.25 um/pixel×256 pixels)×64 um in the specimen 401 when the magnification is 40×, and indicates a range of 128 um×128 um, 256 um×256 um or 512 um×512 um in the specimen when the magnification is 20×, 10× or 5× respectively. For example, one block at the display magnification 10× (256 um×256 um) can display an area that is 16 times (area ratio) one block at the magnification 40× (64 um×64 um).

In the hierarchical image data shown in FIG. 6, it is assumed that the image data is compressed and encoded in each block of the layer image. By executing the image compression in block units, required decoding can be executed in block units, and higher speed screen display can be implemented.

Video data exists as hierarchical image data in which the two-dimensional images are stacked in the time (T) direction. In video data however, the user does not have many chances to visually check, except for observing the entire two-dimensional image in the traveling direction. Therefore in the case of video data, it is unnecessary to consider the method of the present invention for updating the display image at high-speed according to operations to change the horizontal position, the depth position and the magnification, unlike the case of the hierarchical image data that has spatial expanse.

In the case of the file for storing the hierarchical image data shown in FIG. 6, magnification (M) corresponding to each Z stack image, image range in the horizontal (XY) directions, a position in the depth (Z) direction, a number to indicate the position, index information of each block image in the file, and a data storage position or the like are written in the header information. By referring to the file header information, each block image data in the horizontal (XY) directions, depth (Z) direction and magnification (M) specified in the file can be acquired at high-speed.

(Display Update and Data Pre-Read Processing)

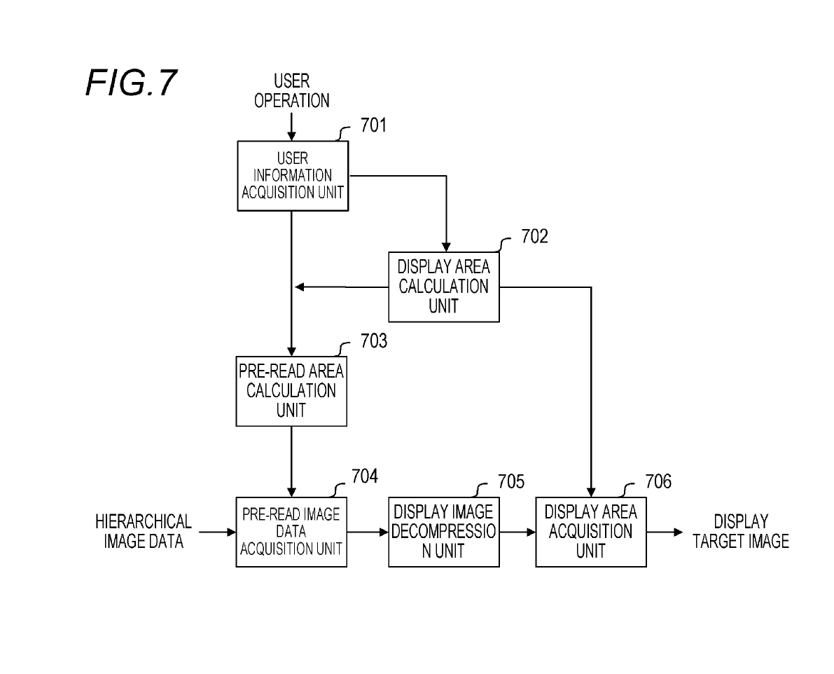

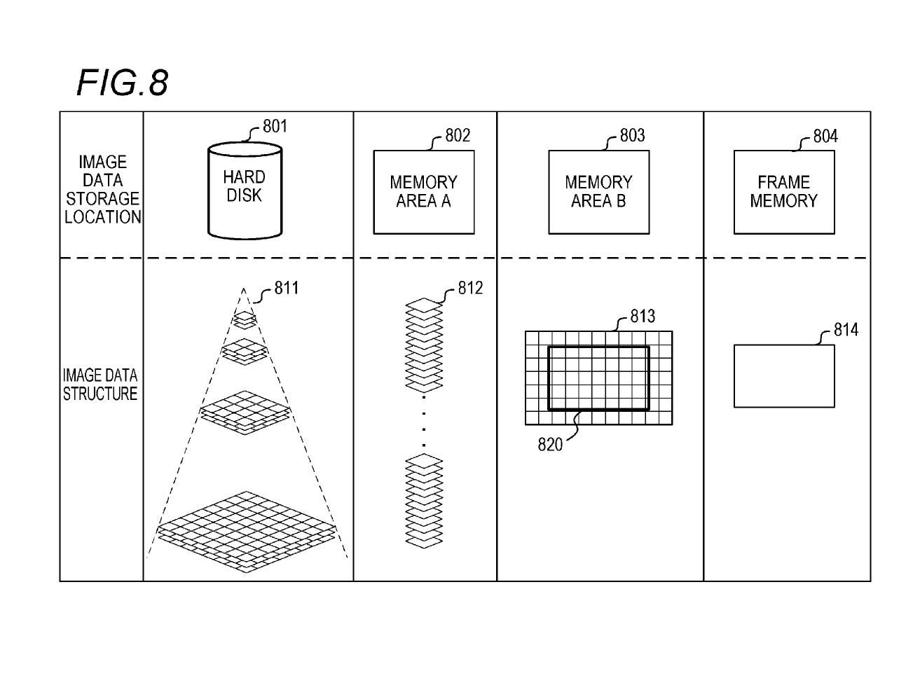

FIG. 7 is a functional block diagram for updating a display image and pre-reading data (controlling buffer) from the hierarchical image data according to the operation for the image display application by the user. In this embodiment, the CPU 301 which executes programs implements these functions, but these functions may be implemented by a dedicated processor board or a logic circuit. FIG. 8 is a diagram depicting a storage location and structure of input/output image data of each unit shown in FIG. 7. Now the display update and data pre-read processing according to the user' operation will be described with reference to FIG. 7 and FIG. 8.

A user information acquisition unit 701 acquires user input information for the image display application on the image generating apparatus 100. The user input information is, for example, a cursor position of the mouse 112, which is an input operation device, display magnification, a display depth position, annotation information stored in the hierarchical image data and various setting information stored in the image display application. Details thereof will be described later.

A display area calculation unit 702 calculates an area of an image to be displayed (display target area) in the display area 205 of the image display application, based on the cursor position of the mouse 112, display magnification, display depth position or the like. Details thereof will be described later. The display area information calculated by the display area calculation unit 702 is outputted to a pre-read area calculation unit 703 and a display area acquisition unit 706 in the subsequent stages.

A pre-read area calculation unit 703, a pre-read image data acquisition unit 704 and a display image decompression unit 705 are functions to predict data to be required for generating a display target image, and control which portion of the hierarchical image data is pre-read (buffered). In this embodiment, the pre-read area calculation unit 703 estimates an image area having a high probability to be displayed next, based on the input information from the user information acquisition unit 701 and the display area information from the display area calculation unit 702, and calculates the pre-read area (area to be stored in the buffer). Details thereof will be described later. The pre-read image data acquisition unit 704 acquires, from the hierarchical image data 811, image data 812 of a sub-block corresponding to the pre-read area calculated by the pre-read area calculation unit 703 (called “block image data”), and outputs this data to a memory area A 802. The memory area A 802 is a buffer for temporarily storing compressed and encoded block image data 812.

The display image decompression unit 705 acquires compressed and encoded block image data 812 from the memory area A 802, decodes this data, and outputs the data to the memory area B 803. The memory area B 803 is a buffer for temporarily storing the decoded decompressed image data 813. In this case, not all the block image data 812 in the memory area A 802 is decompressed in the memory area B 803, but only image data in a sub-block of which probability to be displayed next is sufficiently high is decompressed. Details on how to determine an area (pre-read area) to be stored in the memory area A 802 and the memory B 803 respectively will be described later. As FIG. 8 shows, it is preferable that the decompressed image data 813 is generated so that a margin is created above, below, left and right of the display area 820. For example, one extra column (row) of block image data respectively above, below, left and right of the display area 820 is decompressed. By creating a margin like this, the decompressed image data need not be regenerated even if the image shifts somewhat horizontally, and responsiveness of updating the screen can be improved.

The display area acquisition unit 706 generates display target image data 814 by extracting only the image data in the range corresponding to the display area 820, from the decompressed image data 813 generated by the display image decompression unit 705, and outputs the generated display target image data 814 to a frame memory 804 in the display control device 307. The image data outputted to the frame memory 804 is displayed on the display 120 via the display control device 307.

For the memory area A (802) and the memory area B (803), a part of the area in the main memory 302 of the image generating apparatus 100, may be used, or a part of the area in the buffer memory (not illustrated) in the processor board 303 which is added to increase the speed of the display processing may be used. The location of the frame memory 804 is different depending on the configuration of the image generating apparatus 100, but the area of the frame memory 804 is secured inside the display control device 307 or inside the main memory 302.

The processing by the pre-read image data acquisition unit 704, the display image decompression unit 705 and the display area acquisition unit 706 may be performed in parallel, instead of sequentially performed in serial. For example, the processing by the pre-read image data acquisition unit 704 can be executed at a predetermined time interval. If the pre-read image data acquisition unit 704 has already acquired the data required for decoding, the processing by the display image decompression unit 705 can be executed in parallel with the processing by the pre-read image data acquisition unit 704. The processing by the display area acquisition unit 706 may be executed at a predetermined time interval even if undecoded data exists in the display area 820, or may be executed at the point when decoding in the display area 820 is all completed. If data required for generating image data on the display area 820 does not exist in the memory area A 802 or the memory area B 803, then image data may be directly read from the hard disk 801, and decoded so as to generate display target data. In other words, the sequence of executing the display update and data pre-read processing can be flexibly changed in order to improve responsiveness to update the display screen when the user' operation is received.

According to this embodiment, the hard disk 801 (storage device 130) constitutes the first storage unit that stores the original image data. The memory area A 802 and the memory area B 803, of which speed of reading data is faster than the hard disk 801, constitute the second storage unit that temporarily stores a portion of the original image data. The display area acquisition unit 706 constitutes a generation unit that generates display target image data from the original image data according to an operation by a user. The pre-read area calculation unit 703, the pre-read image data acquisition unit 704, and the display image decompression unit 705 constitute a control unit that predicts data to be used by the generation unit, and controls the data to be stored in the second storage unit.

(Pre-Read Area Calculation Processing)

Internal processing of the pre-read area calculation unit 703 will be described next.

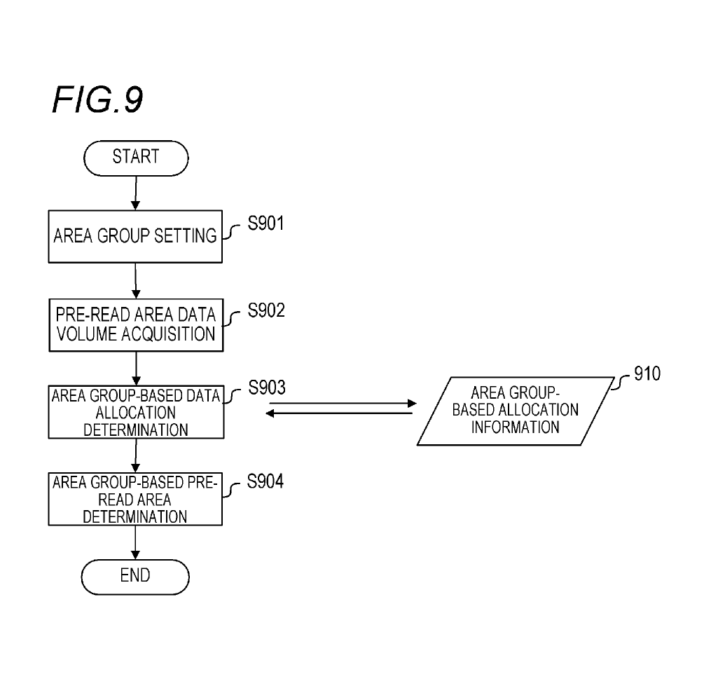

FIG. 9 is a flow chart depicting pre-read area calculation processing, which is internal processing of the pre-read area calculation unit 703. By the processing in FIG. 9, the pre-read area having a high probability that the user would display is calculated based on the user input information from the image display application, so as to improve responsiveness to update the image.

As mentioned above, the user operation includes a plurality of change operations, such as movement of the display target area in the horizontal direction (first change operation), movement of the display target area in the depth direction (second change operation), and change of the display magnification (third change operation). In any of these change operations, a display target image must be updated, but image data required for generating the display target image is different depending on the change operation. In other words, data to be stored in the memory areas A and B (that is, an area to be pre-read from the hierarchical image data) is different depending on the change operation. Therefore this embodiment uses a concept called “area group”, which corresponds to the pre-read area for each change operation. Now processing by the pre-read area calculation unit 703 will be described according to the flow chart in FIG. 9.

First in the area group setting processing S901, the pre-read area calculation unit 703 classifies each layer image (or each sub-block) included in the hierarchical image data into one of the area groups based on a predetermined rule. There may be a layer image (or a sub-block) which is not classified into any of the area groups. As a result of classification, one or more layer images (or sub-groups) are allocated to each area group. Details on the area group or classification will be described later.

Then in the pre-read area data volume acquisition processing S902, the pre-read area calculation unit 703 acquires information required for pre-read area calculation, specifically pre-read data volume (memory amount) for pre-reading in the image generating apparatus 100. The pre-read data volume is a capacity (data size) of the pre-read data (also called “prediction data”) that can be stored in the memory area A and the memory area B respectively. In this embodiment, the pre-read data volume is calculated for the memory area A and the memory are B respectively, but the memory area A and the memory area B may be integrated into one memory area.

If there is no change in the information acquired from the user information acquisition unit 701, the area group setting processing S901 and the pre-read area data volume acquisition processing S902 may be omitted. By reusing the previous calculation values stored in memory, calculation load can be decreased.

In the area group-based data allocation determination processing S903, the pre-read calculation unit 703 refers to area group-based data allocation information 910, and determines allocation of the pre-read data volume to each area group. The area group-based data allocation information 910 used for determining allocation of the pre-read data volume is stored in the storage unit 130 or the main memory 302 in advance.

In the area group-based pre-read area determination processing S904, the pre-read area calculation unit 703 determines, for each area group, a block to be read in the memory area A (pre-read area A) and a block to be read in the memory area B (pre-read area B), based on the allocation of the pre-read data volume.

Each processing in FIG. 9 will now be described in detail.

(Area Group Setting Processing S901)

The area group setting processing S901 will be described in detail.

First a method for expressing an area of the hierarchical image data will be described. If a layer image that can be uniquely specified by the magnification and the depth position is expressed by I (Z, M), and values in the depth (Z) direction and the magnification (M) of the image displayed by the image display application are Zp and Mp respectively, then the layer image to be displayed is I (Zp, Mp).

According to this embodiment, three directions: horizontal (XY), depth (Z) and magnification (M) are used as major directions for change operation in the image observation. Based on this direction information, the layer image of each Z stack image is classified into a horizontal (XY) area group, a depth (Z) area group, and a magnification (M) area group.

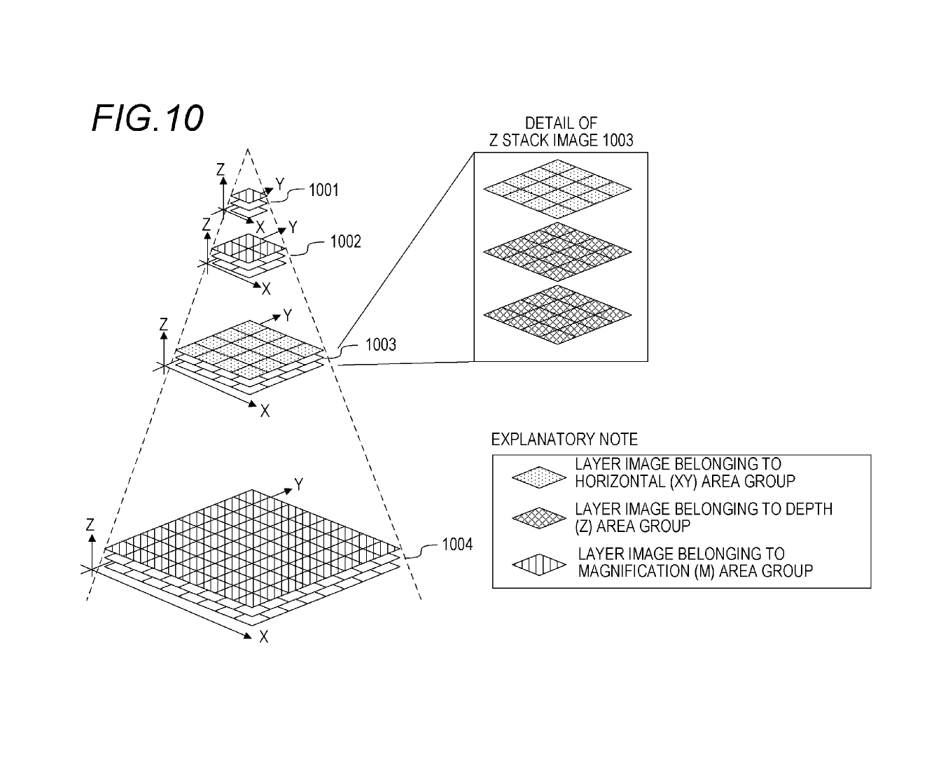

The three area groups will now be described concretely with reference to FIG. 10. It is assumed that, in the current state of the image display application, the display magnification is 20×, and a part of the area of the top layer image (dot pattern) of a Z stack image 1003 is displayed. In this case, the top layer image (dot pattern) of the Z stack image 1003 is set in the horizontal (XY) area group. In the depth (Z) area group, a layer image group (checked pattern), excluding the top layer image of the Z stack image 1003, is set. In the magnification (M) area group, a group of top layer images (vertical line pattern) of the Z stack images 1001, 1002 and 1004 is set.

In more general terms, a layer image I (Zp, Mp) having the same display magnification and depth position as the currently displayed image is classified into the horizontal (XY) area group. A layer image group {I (Zs, Mp)}, of which display magnification is the same as the currently displayed image but of which depth position is different, is classified into the depth (Z) area group. Zs denotes all the depth positions other than the depth position Zp in the currently displayed image, and {I} denotes an image group. A layer image group {I (Zp, Mt)}, of which depth position is the same as the currently displayed image but of which display magnification is different, is classified in the magnification (M) area group. Mt denotes all the display magnifications other than the display magnification Mp of the currently displayed image.

The horizontal (XY) direction may be separated into the lateral (X) direction and the longitudinal (Y) direction, but is described as a single direction in this embodiment. If a layer image having the same depth position Zp does not exist in the Z stack images having different magnifications, a layer image at a position (Zp′) closest to Zp can be substituted.

(Pre-Read Area Data Volume Acquisition Processing S902)

Now details on the pre-read area data volume acquisition processing S902 of this embodiment will be described.

In this embodiment, as the pre-read data volume, memory amounts allocated to the memory area A 802 and the memory area B 803 are acquired. A memory amount that can be allocated for the entire pre-read data volume is set in the image display application in advance. The image display application refers to the maximum memory amount accessible on the OS (Operation System), and calculates the pre-read data volume such that this maximum memory amount is not exceeded.

(Area Group-Based Data Allocation Determination Processing S903)

Now the area group-based data allocation determination processing S903 using the display magnification will be described.

The following description is based on the assumption that the image currently displayed in the display area 205 of the image display application is a part of the top layer image of the Z stack image 603 at the 20× display magnification in FIG. 6.

Table 1 shows an example of the area group-based data allocation information 910 used for the area group-based data allocation determination processing S903.

TABLE 1

| Display | Horizontal | | Magnification |
|---|---|---|---|
| Magnification | (XY) | Depth (Z) | (M) |
| 5 | 80% | 0% | 20% |
| 10 | 60% | 20% | 20% |
| 20 | 40% | 40% | 20% |
| 40 | 20% | 60% | 20% |

The area group-based data allocation information 910 lists the allocation rate of the pre-read data volume for each of the horizontal (XY) area group, the depth (Z) area group and the magnification (M) area group, with respect to the display magnification. In the case of the example of Table 1, if the current display magnification is 5×, the memory amount is allocated at 80% to the horizontal (XY) area group, at 0% to the depth (Z) area group, and at 20% to the magnification (M) area group. If the current display magnification is 40×, the memory amount is allocated at 20% to the horizontal (XY) area group, at 60% to the depth (Z) area group, and at 20% to the magnification (M) area group.

This allocation ratio is derived based on the observation flow in pathological diagnosis by a pathologist. For example, the 5× low magnification image is often used by a pathologist to generally observe the entire specimen, and find a region of interest that is required observation in detail. Therefore if a low magnification image is displayed, movement is mostly performed in the horizontal (XY) direction, and movement in the depth (Z) direction is rare. This is why a large memory amount is allocated to the horizontal (XY) area group. If an image is displayed at 40× high magnification, on the other hand, it is often in the case of observing the specimen in detail after regions of interest are detected. This means that movement in the horizontal (XY) direction is expected to be minimal. This is why more memory amount (60%) is allocated to the depth (Z) area group than to the horizontal (XY) area group. In the case of the example in Table 1, the allocation ratio of the pre-read data volume of the magnification (M) area group is fixed (20%), so that the user can change magnification easily. The allocation to the magnification (M) area group may be changed according to the current display magnification.

It is assumed that the memory amounts allocated to the memory areas A and B, acquired by the pre-read area data volume acquisition processing S902, are 125 MB respectively. According to Table 1, the memory allocation amounts to the horizontal (XY) area group, the depth (Z) area group, and the magnification (M) area group, when the current display magnification is 20×, are calculated as 50 MB, 50 MB and 25 MB respectively.

(Area Group-Based Pre-Read Area Determination Processing S904)

Now details on the area group-based pre-read area determination processing S904 will be described. The method for determining the pre-read area B will be described first, since the pre-read area A to be stored in the memory area A 802 can be calculated in almost the same way as the pre-read area B to be stored in the memory area B 803. Hereafter the pre-read area for the horizontal (XY) area group is called “horizontal (XY) pre-read area”. In the same way, the pre-read areas for the depth (Z) area group, and for the magnification (M) area group are called “depth (Z) pre-read area” and “magnification (M) pre-read area” respectively.

The method for calculating the magnification (M) pre-read area will be described first.

If the number of Z stack images acquired at different magnifications (M) is W, W=4 in the case of FIG. 10. A magnification (M) area group includes W−1 number of layer images, (the image acquired at the current magnification is not included). In this embodiment, an equal sized pre-read area is secured for each of the W−1 number of layer images.

Since the memory amount allocated to the magnification (M) area group in the processing in S903 is 25 MB, the memory amount per layer image belonging to the magnification (M) area group is 25/(W−1)=25/3=8.3 [MB].

If the pre-read area has M number of horizontal pixels and N number of vertical pixels, and the ratio of M and N is the same as the aspect ratio of the screen display size (1920×1200 pixels), that is M=1.6×N, then M=2154 and N=1346. If the number of horizontal pixels and the number of vertical pixels are determined to be integral multiples of the sub-block size, in a range not exceeding M and N respectively, then the number of horizontal pixels is 2048, and the number of vertical pixels is 1280. This calculation is based on the fact that the vertical and horizontal sizes of the sub-block are 256 pixels respectively.

Next a method for calculating the horizontal (XY) pre-read area and the depth (Z) pre-read area will be described.

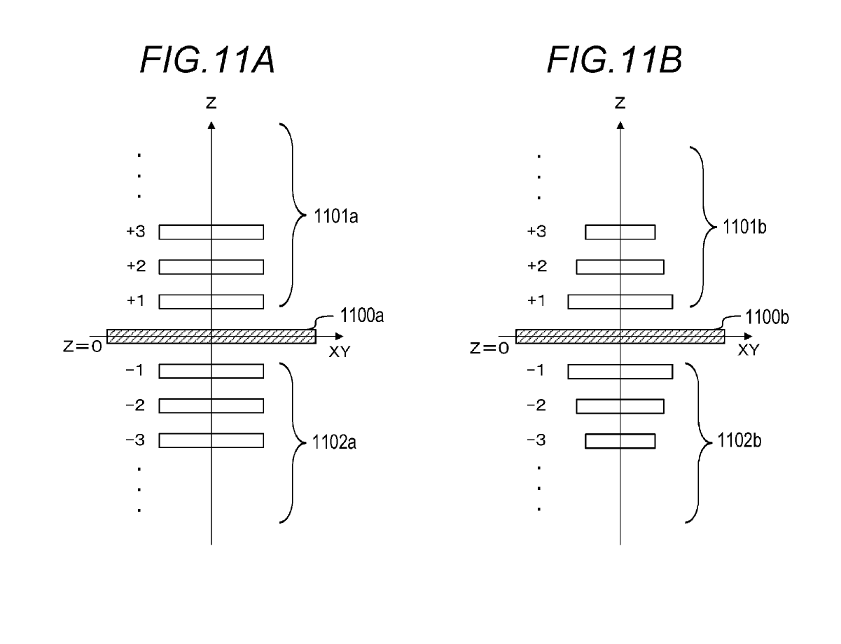

FIG. 11A and FIG. 11B are schematic diagrams depicting a horizontal (XY) pre-read area and a depth (Z) pre-read area to be loaded in the memory area B, which are determined based on the above mentioned memory allocation ratio. FIG. 11A is an example of loading the same sized image data at all the depth positions, and FIG. 11B is an example of changing the size of an image data depending on the depth position.

If the horizontal (XY) pre-read area (1100a) is calculated using the maximum memory amount that is allocated, the horizontal size M and the vertical size N are calculated as follows.

[Math. 1]

N=sqrt(asign_mem_{—}xy/pix_Byte/aspect) (1)

M=1.6×N (2)

The number of pixels Sx in the X direction and the number of pixels Sy in the Y direction to be integral multiples of the sub-block size, in a range not exceeding M and N respectively, are calculated as follows.

[Math. 2]

Sx=floor(aspect×N/block_{—}x)×block_{—}x (3)

Sy=floor(N/block_{—}y)×block_{—}y (4)

Here floor (x) is a function to determine a maximum integer in a range not exceeding x, and sqrt (x) denotes a function to determine the square root of x. The meaning of each variable is as follows.

N: maximum length in the Y direction when a pre-read area is calculated to have an aspect ratio of the screen display size (value that does not consider a sub-block)

block_x: length of sub-block in X direction

block_y: length of sub-block in Y direction

asign_mem_xy: memory amount allocated to the horizontal (XY) area group [Byte]

pix_Byte: the number of bytes in a pixel

aspect: aspect ratio (horizontal/vertical) of screen display size

In the case of FIG. 11A, the number of images in the depth direction (D) in the depth (Z) pre-read areas (1101a and 1102a), of which center is the depth position (Zp) of the image currently displayed by the image display application, can be calculated as follows.

[Math. 3]

Sx=ceil(x_disp/block_{—}x)×block_{—}x (5)

Sy=cell(y_disp/block_{—}y)×block_{—}y (6)

D=floor(asign_mem_{—}z/(Sx×Sy×pix_Byte)) (7)

Here ceil (x) is a function to determine a minimum integer that exceeds x.

The meaning of each variable is as follows.

x_disp: the number of pixels to pre-read in the X direction (value that does not consider a sub-block)

y_disp: the number of pixels to pre-read in the Y direction (value that does not consider a sub-block)

asign_mem_z: memory amount allocated to the depth (Z) area group [Byte]

In the above expressions, the following values are substituted as examples.

block_x=block_y=256

pix_Byte=3 (set to 3 bytes assuming RGB colors are used)

aspect=1920/1200

x_disp=1920

y_disp=1200

The current display magnification is assumed to be 5×, and the memory amounts allocated to the horizontal (XY) area group and the depth (Z) area group are as follows.

asign_mem_xy=104857600 (=100 MB)

asign_mem_z=0

As a result, the horizontal (XY) pre-read area and the depth (Z) pre-read area can be determined as shown in Table 2.

TABLE 2

| Display | | | | Screen cover |
|---|---|---|---|---|
| Magnification | Pre-read area of each area group | | | ratio (%) |
| 5X | Horizontal | Number of pixels (X) | 7424 | 387 |
| | | Number of pixels (Y) | 4608 | 384 |
| | Depth | Number of pixels (X) | 0 | 0 |
| | | Number of pixels (Y) | 0 | 0 |
| | | Number of images (Z) | 0 | — |

“Screen cover ratio” indicates a percentage of an area, which number of pixels secured for the horizontal (XY) pre-read area in the memory area B covers the vertical and horizontal size of the screen display. As this number becomes higher, an area where the screen can be updated at high-speed with respect to the movement in the horizontal direction or the depth direction is wider, that is there is less access to the low speed memory or storage media.

As the result in Table 2 shows, in the case of low magnification (5×), the responsiveness to update the screen with respect to the movement in the horizontal (XY) direction is high. Now Table 3, Table 4 and Table 5 show the pre-read area for each area group when the display magnification is 10×, 20× and 40× respectively.

The memory allocation at 10× magnification is as follows.

asign_mem_xy=78643200 (=75 MB)

asign_mem_z=26214400 (=25 MB)

The memory allocation at 20× magnification is as follows.

asign_mem_xy=52428800 (=50 MB)

asign_mem_z=52428800 (=50 MB)

The memory allocation at 40× magnification is as follows.

asign_mem_xy=26214400 (=25 MB)

asign_mem_z=78643200 (=75 MB)

TABLE 3

| Display | | | | Screen cover |
|---|---|---|---|---|
| Magnification | Pre-read area of each area group | | | ratio (%) |
| 10X | Horizontal | Number of pixels (X) | 6400 | 333 |
| | | Number of pixels (Y) | 3840 | 320 |
| | Depth | Number of pixels (X) | 2048 | 107 |
| | | Number of pixels (Y) | 1280 | 107 |
| | | Number of images (Z) | 3 | — |

TABLE 4

| Display | | | | Screen cover |
|---|---|---|---|---|
| Magnification | Pre-read area of each area group | | | ratio (%) |
| 20X | Horizontal | Number of pixels (X) | 5120 | 267 |
| | | Number of pixels (Y) | 3072 | 256 |
| | Depth | Number of pixels (X) | 2048 | 107 |
| | | Number of pixels (Y) | 1280 | 107 |
| | | Number of images (Z) | 6 | — |

TABLE 5

| Display | | | | Screen cover |
|---|---|---|---|---|
| Magnification | Pre-read area of each area group | | | ratio (%) |
| 40X | Horizontal | Number of pixels (X) | 3584 | 187 |
| | | Number of pixels (Y) | 2304 | 192 |
| | Depth | Number of pixels (X) | 2048 | 107 |
| | | Number of pixels (Y) | 1280 | 107 |
| | | Number of images (Z) | 10 | — |

As Table 3 to Table 5 show, as the magnification increases as in 10×, 20× and 40×, the number of pre-read images in the depth direction increases while the screen cover ratio in the horizontal direction decreases. This matches with user' needs well. In the case of low magnification, the general area is checked, therefore the response performance to update the screen with respect to the movement in the horizontal direction is important. As magnification increases, the depth of field decreases, therefore the frequency of observing in the depth direction increases, the response performance to update the screen in the depth direction is important.

The pre-read area using the area group-based data allocation information 910 shown in Table 1 was described above using an example, but the calculation method in the area group-based pre-read area determination processing S904 is not limited to the above example. A modification thereof will be described.

FIG. 11B is an example when the size of the pre-read area is smaller as the pre-read area becomes more distant from the currently displayed depth position (Zp). In FIG. 11B, the currently displayed depth position (Zp) is “0”, and the depth position increments as “+1”, “+2” . . . as the distance increases step by step in the plus direction, and decrements as “−1”, “−2” . . . as the distance decreases step by step in the minus direction.

For example, the memory amount that is allocated to the depth positions (Zp+1) and (Zp−1), which are one step away from the current depth position (Zp), is a [MB] respectively, and the memory amount to be allocated becomes r times (r<1) every time the depth position is distant one more step respectively.

The memory amount b [MB] of the pre-read area at the depth position (Z) is as follows.

[Math. 4]

b=a×r^{Z-(Zp+1)}(Z>Zp+1) (8)

b=a×r^{Z-(Zp-1)}(Z<Zp−1) (9)

The memory amount required for storing all the depth pre-read areas is the total memory amount b of each depth position given by Expression (8) and Expression (9). Here the sum of Expression (8) and the sum of Expression (9) are both geometric series, hence the maximum memory amount d [MB] is as follows, even if the number of layer images existing in the depth direction is high.

$$\begin{matrix}[ Math . 5 ] & \\ d = 2 \times \frac{a}{1 - r} & ( 10 )\end{matrix}$$

For example, in Expression (10), the maximum memory amount is 4a [MB] if r=1/2. When 4a [MB] of the memory amount is allocated to the depth (Z) area group, only four image data can be pre-read if the same data mount a [MB] of data is read from each depth position, as in the case of FIG. 11A. If the size of the pre-read area is changed depending on the depth position, however, image data can be pre-read from a wider range in the depth direction. The method of changing the size is not limited to the example in FIG. 11B, but the same effect can be implemented by decreasing the size gradually or in steps, as the depth position becomes more distant from the currently displayed depth position (Zp). To decrease the size, it is preferable to align the center in the horizontal (XY) direction of the pre-read area at each depth position, as shown in FIG. 11B. Thereby high-speed image update becomes possible at least for the center portion of the screen. It is highly possible that an area of interest of the user is in the center portion of the screen, so if the responsivity to update the display of the center portion of the screen is good, even if display of the edges of the screen is slow, the wait time to observe depth images and stress due to the waiting can be decreased.

(Modification Example of Calculation Method)

As another calculation method in the area group-based pre-read area determination processing S904, the pre-read area may be determined so that all the images in the depth direction can be displayed using the number of images (D) in the depth direction at a display magnification.

For example, the number of images in the depth direction at 40× magnification is D=26, and the memory allocation to the depth (Z) area group is 75 MB, then the number of images allocated to the depth (Z) area group is D−1, and the memory amount per image is 75/(26−1)=3 [MB]. If the pre-read area has M horizontal pixels and N vertical pixels, and the ratio of M and N is the same as the aspect ratio of the screen display size, that is, M=1.6×N, then M=1295 and N=810. If the number of horizontal pixels and the number of vertical pixels are determined to be integral multiples of the sub-block size, in a range not exceeding M and N respectively, then the number of horizontal pixels is 1280 and the number of vertical pixels is 768.

The above mentioned calculation method in the area group-based data allocation determination processing S903 may be set linking with the setting of the image display application. In this case, the user may set the calculation method in the image display application setting screen.

A pre-read area determination method for the pre-read area A to be stored in the memory area A 802 will now be described. The pre-read area A to be stored in the memory area A 802 can be determined by the same method as the case of the memory area B 803 described above. The difference is that the virtual memory amount of the memory area A 802 becomes larger since the compressed and encoded image data in the original hierarchical image data is stored in the memory area A 802. If the compression rate is 1/10, for example, when the memory area A and the memory area B have the same memory amount, the memory area A can store sub-block image data 10 times more than that of memory area B.

Here if the memory amount allocated to an area group is higher than the total data volume of the sub-blocks classified in this area group, there are some handling methods. One is reallocating the excess memory amount to another area group, and another is releasing the excess memory amount from the memory area A without allocating the excess memory amount to another area group. The former can expand the pre-read range in the other area group, and the respond speed to update the screen can be increased. The latter suppresses the memory used by the image display application, and increases memory amount that can be allocated to other computer programs whereby the operation of the computer programs can be smooth. Either method can be used according to the intended use.

For the compression rate of the original hierarchical image data, information on the data compression rate written in the file header of the hierarchical image data is used. Even if the data compression rate is not written in the header information, the image data size in an uncompressed state can be calculated based on the number of pixels in the horizontal (XY) direction of the image data, and the number of images in the magnification (M) direction and the depth (Z) direction, which are written in the header information. Therefore, the compression rate of the image data can be determined by comparing the above mentioned image data size in an uncompressed state with the file size after compression written in the header information.

Thus far the internal processing of the pre-read area calculation unit 703 was described.

(Internal Processing of Pre-Read Image Data Acquisition Unit 704)

The internal processing of the pre-read image data acquisition unit 704 will be described next.

The pre-read image data acquisition unit 704 acquires the image data of the pre-read area A determined by the pre-read area calculation unit 703 from the file in which the hierarchical image data is stored. In this case, an image data group on sub-blocks which were acquired according to the previous user input information may already exist in the memory area A 802. Therefore when data is acquired, the pre-read image data acquisition unit 704 first creates a “memory area A acquisition scheduled image list” where index information of all the sub-blocks, which are scheduled to be acquired, is recorded. The index information of sub-blocks which is currently stored in the memory area A 802 is written in the “memory area A acquired image list”. The pre-read image data acquisition unit 704 updates the content of the memory area A acquired image list every time image data of a sub-block is written in the memory area A 802, or image data is deleted from the memory area A 802.

The pre-read image data acquisition unit 704 compares the memory area A acquired image list and the memory area A acquisition scheduled image list, and creates a “memory area A retention scheduled image list”, a “memory area A release scheduled image list” and a “memory area A update scheduled image list”. The memory area A retention scheduled image list is a list that stores index information on the sub-blocks which exist in both the memory area A acquired image list and the memory area A acquisition scheduled image list. The memory area A release scheduled image list is a list that stores index information on the sub-blocks which are included in the memory area A acquired image list but not included in the memory area A acquisition scheduled image list. The memory area A update scheduled image list is a list that stores index information on the sub-blocks which are included in the memory area A acquisition scheduled image list but not included in the memory area A acquired image list.

Then the pre-read image data acquisition unit 704 releases the image data on the sub-blocks described in the memory area A release scheduled image list from the memory area A, and writes the image data on sub-blocks described in the memory area A update scheduled image list into the memory area A. Thereby only the image data on the sub-blocks which currently do not exist in the memory area A can be efficiently acquired, and the response speed can be increased.

In order to improve responsivity to update the screen, it is preferable that the acquisition sequence is determined for each area group and each sub-block, so that information which is highly probable that the user would check can be acquired with priority. It is preferable that the acquisition sequence of image data of sub-blocks included in the pre-read area B is set to be higher than the other image data. An example of the acquisition sequence based on the area group is the sequence of the horizontal (XY) area group, magnification (M) area group and the depth (Z) area group. Within each area group, it is preferable that the sequence to acquire the image data is determined so that the sub-block closer to the currently displayed area is read first, that is, from the shortest distance from the boundary line of the currently displayed area. Various other settings are possible for the sequence of acquisition. The sequence of releasing the block image data from the memory area A can be determined in the reverse order of the above mentioned acquisition sequence. If sub-blocks can be acquired in parallel, the response speed to update the screen can be increased if the sub-blocks are acquired in parallel sequentially from the top of the above mentioned acquisition sequence.

Thus far the internal processing of the pre-read image data acquisition unit 704 was described.

(Internal Processing of Display Image Decompression Unit 705)

The internal processing of the display image decompression unit 705 will be described next.

In the display image decompression unit 705 as well, only the image data of the undecoded sub-blocks can be efficiently processed and response speed can be increased, by creating and comparing the lists before and after the processing, just like the case of the pre-read image data acquisition unit 704.

Out of the compressed and encoded image data of sub-blocks stored in the memory area A, the display image decompression unit 705 decodes image data of sub-blocks corresponding to the pre-read area B determined by the pre-read area calculation unit 703, and decompresses the data in the memory area B.

When the image data of the sub-blocks is decoded, the display image decompression unit 705 first creates a “memory area B decode scheduled image list” where index information of all the sub-blocks, which are scheduled to be decoded, is recorded. The index information of sub-blocks, which is currently stored in the memory area B, is recorded in a “memory area B decoded image list”, and the display image decompression unit 705 updates the content of the decoded image list every time the image data of the memory area B is updated.

The display image decompression unit 705 compares the memory area B decoded image list and the memory area B decode scheduled image list, and creates a “memory area B retention scheduled image list”, a “memory area B release scheduled image list”, and a “memory area B update scheduled image list”. The memory area B retention scheduled image list is a list that stores index information on the sub-blocks which exist in both the memory area B decoded image list and the memory area B decode scheduled image list. The memory area B release scheduled image list is a list that stores index information on the sub-blocks which are included in the memory area B decoded image list, but not included in the memory area B decode scheduled image list. The memory area B update scheduled image list is a list that stores index information on the sub-blocks which are included in the memory area B decode scheduled image list, but not included in the memory area B decoded image list.

Then the display image decompression unit 705 releases the image data on the sub-blocks described in the memory area B release scheduled image list from the memory area B, and decodes the image data on the sub-blocks described in the memory area B update scheduled image list, and writes the decoded data to the memory area B. Thereby only the image data on the sub-blocks, which do not exist in the memory area B, can be efficiently decoded, and the response speed can be increased.

Just like the processing of the pre-read image data acquisition unit 704, the response speed to update the screen can be increased by determining the acquisition sequence or the release sequence for each area group and each sub-block, or by executing processing in parallel. In the memory area B, decompression is not limited to one image, but a plurality of image data can be decompressed as shown in FIG. 8. For example, if a number of images are pre-read in the depth direction and b number of images are pre-read in the magnification direction, a+b+1 number of image data, including the currently displayed image, is stored in the memory area B. If image data on a plurality of sub-blocks constituting one image is decompressed into discontinuous addresses in the memory area B, it is preferable that the memory is rearranged so that data constituting a same image is stored in continuous addresses on memory as much as possible. Thereby the display area acquisition processing in the subsequent stage can be faster, and display responsivity can be further improved.

Thus far the internal processing of the display image decompression unit 705 was described.

(Internal Processing of Display Area Acquisition Processing 706)

The internal processing of the display area acquisition unit 706 will be described next.

The display area acquisition unit 706 acquires image data in a range corresponding to the display area 820, out of the image data decompressed on the memory area B, and transfers the acquired image data to the frame memory 804 as display target image data.

The image data decompressed on the memory area B has some margin for the display area 820, hence responsiveness to update the screen with respect to the parallel movement in the horizontal direction is high.

The display setting of the image display application may include zoom in/out and rotation. Zoom in/out and rotation of an image is implemented by the display area acquisition unit 706 calculating coordinates before zoom in/out or before rotation, calculating pixel values corresponding to the coordinates by interpolation, decompressing the image on a new memory, and transferring this data to the frame memory 804. In this case however, the display area calculation unit 702 must calculate the coordinates before zoom in/out or before rotation.

Zoom in is used to display an image at an intermediate magnification, such as image data at 30× magnification, which does not exist in the hierarchical image data. In this case, if zoom in is executed using image data at highest magnification that does not exceed this intermediate magnification, a wide area of screen display can be covered using little memory amount. Zoom out can also be used to display an image at an intermediate magnification that does not exist in the hierarchical image data. In this case, zoom out can be executed using image data at lowest magnification that exceeds this intermediate magnification. If the zoom in ratio is extremely high, it is better to use zoom out to maintain the image quality.

This processing may be implemented using the functions of the GPU (Graphics Processing Unit), which has high computing capability and which exists in the display control device 307, instead of the CPU 301 and the processor board 303.

(Advantages of this Embodiment)

As described above, according to this embodiment, data to be pre-read is predicted for each area group corresponding to the change operation by the user, such as movement in the horizontal direction, movement in the depth direction and change of the magnification, and predicted data is loaded onto high speed memory areas A and B in advance. Therefore when the user executes a change of operation, required data can be read from a high-speed memory, instead of a low-speed device (e.g. hard disk, image server) where original hierarchical image data is stored, and responsivity to update the display image can be improved. Further, according to this embodiment, the memory capacity can be allocated for each area group (for each change operation), hence flexible control, such as allocating more memory adaptively to a change operation of which generation probability is high, is possible. As a result, utilization efficiency of the buffer memory improves and access frequency to a low-speed device can be decreased, that is, response speed of the image display application can be increased. Particularly in this embodiment, focusing on the tendency of the operation the user executes during the image observation, such as pathological diagnosis, the allocation of the memory capacity is automatically changed according to the current display magnification, therefore further improvement of responsivity to the user' operation can be expected.

In this embodiment, the allocation of the memory capacity is automatically changed, but the user may directly specify the allocation of the memory capacity on the image display application, or edit the content of the area group-based data allocation information 910.

### Embodiment 2

In Embodiment 2, a method for determining an allocation ratio of the pre-read data for each area group, based on a setting mode which the user can set, will be described.

The pathological diagnosis is mainly divided into histological diagnosis and cytological diagnosis. Generally in the histological diagnosis, a thin sample, sliced at a predetermined thickness, is used, and a shape of a plurality of cells and tissues is observed rather than a shape of an individual cell. Therefore, in histological diagnosis, a pathologist often observes the sample using an image at a relatively low magnification, while moving the display area in the horizontal direction. In the case of cytological diagnosis, on the other hand, a relatively thick sample acquired by exfoliation, for example, is used, and observation at a high magnification and a change of depth position are often performed.

Therefore it is preferable that a function for the user to set a diagnosis mode is provided in the image display application (e.g. allowing the user to select histological diagnosis or cytological diagnosis), and the pre-read area calculation unit 703 changes the allocation of the memory capacity for each area group according to the diagnosis mode that is set.

Table 6 is an example of the area group-based data allocation information 910 used in this embodiment. A ratio of memory capacity allocated to each area group is set for each diagnosis mode. In the case of the histological diagnosis mode, allocation to the horizontal (XY) area is increased since movement in the horizontal direction is often used. In the case of the cytological diagnosis mode, on the other hand, movement in the depth direction is also used, so a same memory capacity is allocated to both the horizontal (XY) area group and the depth (Z) area group.

TABLE 6

| | Horizontal | Depth | Magnification |
|---|---|---|---|
| Diagnosis Mode | (XY) | (Z) | (M) |
| Histological diagnosis | 60% | 20% | 20% |
| Cytological diagnosis | 40% | 40% | 20% |

Beside diagnosis mode, a mode that can specify priority operation out of a plurality of change operations (called “pre-read mode”) may be provided, so that the user can select a pre-read mode in the image display application. Table 7 is an example of the area group-based data allocation information 910 for the pre-read mode.

TABLE 7

| Pre-read Mode | Horizontal (XY) | Depth (Z) | Magnification (M) |
|---|---|---|---|
| Horizontal only | 80% | 0% | 20% |
| Emphasis on | 60% | 20% | 20% |
| horizontal | | | |
| Balance | 40% | 40% | 20% |
| Emphasis on depth | 20% | 60% | 20% |

In the example in Table 7, a desired mode can be selected out of four pre-read modes. For example, “Emphasis on depth” mode is set if the user wants to switch an image in the depth direction to know the three-dimensional structure of the specimen. “Horizontal only” mode or “Emphasis on horizontal” mode is set if the user frequently moves the image in the horizontal direction. To perform observation in both the horizontal direction and the depth direction, “Balance” mode is set.

It is preferable that switching of the mode can be specified in a mode setting screen (not illustrated) provided by the image display application, using the keyboard 111 or the mouse 112. If the image display application can display a plurality of images, mode may be set for each image.

According to the configuration of the embodiment described above, allocation of the memory capacity is changed depending on the mode selected by the user, therefore data in the area where the possibility for the user to check is high can be pre-read, and utilization efficiency of the buffer memory can be further improved. Furthermore, the user can directly select a mode, hence responsivity to update the image can be improved even if observation is performed by a method that is different from a standard method (e.g. frequently switching the depth position in an image for histological diagnosis, or in an image at low magnification).

### Embodiment 3

In Embodiment 3, a method for determining an allocation ratio of the pre-read data for each group, based on annotation information attached to the image data will be described.

As FIG. 2 shows, in some cases annotation information 207 is attached to an image currently displayed on the image display application. The annotation information 207 is comment information created by the user, and is attached to a region of interest (ROI) in the image (e.g. an area where an abnormality is recognized in the image, an area where detailed observation is needed) in many cases. If such annotation information 207 exists, it is highly possible that the user would increase the display magnification of the image to perform detailed observation. Therefore it is preferable to apply a rule to expand the pre-read area of the magnification (M) area group.

Table 8 shows an example of the area group-based data allocation information 910.

TABLE 8

| Annotation | Horizontal (XY) | Magnification (M) |
|---|---|---|
| No | 100% | 0% |
| Yes | 75% | 25% |

According to Table 8, if annotation information does not exist on the currently displayed image, the 100 MB of memory amount allocated to the memory area B is all allocated to the horizontal (XY) area group. As a result, the pre-read area, the same as Table 2, is acquired.

If annotation information exists on the currently displayed image, 75 MB of memory is allocated to the horizontal (XY) area group, and 25 MB of memory is allocated to the magnification (M) area group. If the pre-read area of the horizontal (XY) area group is calculated based on Table 8, then the result is that the number of pixels in the X direction is 6400, and the number of pixels in the Y direction is 3840.

If it is assumed that the pre-read area of the magnification (M) area group secures an equal area for W number of magnifications, other than the current display magnification, then a memory amount per image is calculated as 25/3=8.3 [MB], and if it is assumed that the pre-read area is M horizontal pixels by N vertical pixels, and the aspect ratio of N and M is the same as that of the screen display size, that is M=1.6×N, then M=2154 and N=1346. If the number of horizontal pixels and the number of vertical pixels are determined to be integral multiples of the sub-block size, in a range not exceeding M and N respectively, then the number of horizontal pixels is 2048, and the number of vertical pixels is 1280.

Besides Table 8, various allocation ratios are possible.

For example, if the probability to check images in the depth direction is high when annotation information exists, it is preferable to increase the pre-read data volume not only for the magnification (M) area group, but also for the depth (Z) area group.

The pre-read area for each area group may be controlled according to the relationship between the magnification or depth position of the display image when the annotation information is attached, and the current display magnification or depth position. For example, if the annotation information is information attached for the display magnification that is different from the current display magnification, then the allocation ratio of the magnification (M) area group is increased. In the same manner, if the annotation information is information attached for the depth position that is different from the current depth position, then the allocation ratio of the depth (Z) area group can be increased. This is because it is highly probable that the user would change the display magnification or the depth position of the image in order to check the image at the display magnification or depth position when the annotation information was attached.

If annotation information is attached somewhere in the hierarchical image data, even if annotation information does not exist on the image (in the area) that is currently displayed in the display area 205, the allocation ratio of the memory for each area group may be controlled based on this annotation information. For example, if the positions where annotation information is attached are dispersed in the horizontal direction, the allocation ratio to the horizontal (XY) area group may be increased. If the positions where annotation information is attached are dispersed in the magnification direction, the allocation ratio to the magnification (M) area group may be increased. If all the positions where annotation information is attached in the hierarchical image data are recorded in the header information of the hierarchical image data, the above mentioned processing can be executed at high-speed.

According to the above mentioned configuration of this embodiment, the allocation of the memory capacity is changed depending on whether annotation information is attached to the image, and depending on the locations of the annotation information, therefore responsivity to update the image can be further improved when observation is performed focusing on annotation information.

### Embodiment 4

In Embodiment 4, a method for determining an allocation ratio of the pre-read data for each area group according to the change operation history of the user will be described.

In the operation to check an image displayed on the image display application, the frequency of zoom in/out and the change of depth position are influenced by the features of an object and characteristics of the user who observes the object. Therefore in this embodiment, the change operations performed in the image display application are recorded for each object or for each user, and the allocation of the memory for each area group is changed based on this history information. Thereby appropriate pre-reading of data, matching with the features of the object and the tendencies of the user who observes the object can be implemented.

An example of history information of a change operation by the user is information on the number of times of changing the horizontal position, depth position and display magnification in the hierarchical image data to be displayed. As an example, Table 9 shows the area group-based data allocation information corresponding to the number of times of changing the display position in the depth direction, in the hierarchical image data.

TABLE 9

| Number of | Horizontal | | Magnification |
|---|---|---|---|
| times of change | (XY) | Depth (Z) | (M) |
| 0 | 80% | 0% | 20% |
| 1 or more | 60% | 20% | 20% |

In Table 9, when the number of times of changing the depth position is 0, the ratio of the memory amount allocated to the depth (Z) area group is 0%, but when the number of times of changing the depth position is at least 1, the ratio of the memory amount allocation to the depth (Z) area group is increased to 20%. Thereby the pre-read area of the image in the depth (Z) direction is increased, and responsivity to update the screen when the depth position is changed can be improved.

### Embodiment 5

In Embodiment 5, a method for determining an allocation ratio of the pre-read data for each area group according to the identification information of the user, such as the user ID used for login to the image generating apparatus 100 or a user ID that is set in the image display application, will be described.

A technician who performs a screening operation to determine whether an affected area exists in the object normally observes an image at a predetermined magnification while moving the display area gradually in the horizontal direction, so that no area is missed. Therefore importance is placed on pre-read in the horizontal direction in the case of observation by a technician. A pathologist who observes the affected area closely and performs pathological diagnosis, on the other hand, tends to more frequently change the magnification and depth position compared with a technician. Therefore it is preferable to determine, depending on the user ID, whether the user is an individual who performs screening operation (e.g. technician) or an individual who performs detailed observation (e.g. pathologist), so that in the former case, allocation is determined focusing on the horizontal direction, and in the latter case, allocation is determined considering the movement in the depth direction and the change of magnification as well.

Table 10 is an example of the area group-based data allocation information 910 when the allocation ratio for each area group is changed depending on the group where the user belongs. According to the above mentioned observation characteristics, the pre-read area for the horizontal (XY) direction is increased for the technician group, and the pre-read area for the depth (Z) direction is increased for the pathologist group.

TABLE 10

| Group | Horizontal (XY) | Depth (Z) | Magnification (M) |
|---|---|---|---|
| Technician | 60% | 20% | 20% |
| Pathologist | 40% | 40% | 20% |

By changing the data allocation volume for each area group depending on the user as described above, pre-reading matching the operation tendencies of the user becomes possible, and responsivity to update the image can be improved.

### Embodiment 6

In Embodiment 6, a method for determining the allocation ratio of the pre-read data for each area group depending on the type of specimen 401 will be described.

In Embodiment 2, a method for changing the pre-read area for each area group depending on the diagnosis mode, whether it is histological diagnosis or cytological diagnosis, was described. For histological diagnosis, HE (Haematoxylin and Eosin) staining is often used, and for cytological diagnosis, Papanicolaou staining and Giemsa staining are often used. Therefore if a type of staining used for the specimen 401 is known, it can be determined whether the hierarchical image data is data for histological diagnosis or data for cytological diagnosis. In this embodiment, the area group-based data allocation information 910 corresponding to the staining performed on the specimen 401, such as HE staining, Papanicolaou staining or Giemsa staining, is used, therefore it is not necessary for the user to set the diagnosis mode.

Table 11 is an example of the area group-based data allocation information 910 in the case of changing the allocation ratio assigned to each area group depending on the staining performed on the specimen. According to the observation characteristics described in Embodiment 2, the pre-read area in the horizontal (XY) direction is increased in the case of HE staining, and the pre-read area in the depth (Z) direction is increased for Papanicolaou staining and Giemsa staining.

TABLE 11

| Staining | Horizontal (XY) | Depth (Z) | Magnification (M) |
|---|---|---|---|
| HE | 60% | 20% | 20% |
| Papanicolaou | 40% | 40% | 20% |
| Giemsa | 40% | 40% | 20% |

The information on the staining method performed for the specimen 401 may be written in barcode on the label area 412 on the slide shown in FIG. 4. In this case, the image display application may read this information. In the case when the staining method is written in the header information of the file of the hierarchical image data as well, this information can be acquired via the image display application. Even if the staining method is not written in the label area 412 or in the header information of the file, the image display application can analyze data of the thumbnail image 203 or data of the display area 205, and estimate the staining method based on such information as color. Besides staining performed on the specimen 401, information written in the label area 412, such as information on an organ from which the specimen was sampled, can be used. For example, in the case of an organ which must be zoomed in frequently in observation, the data allocation volume for the magnification (M) area group can be increased.

As described above, responsivity to update the image can be improved by changing the area group-based pre-read area, using information on a type of specimen, such as information on staining performed on the specimen and information on the organ.

### Embodiment 7

In Embodiment 7, a case of using hierarchical image data constituted by a plurality of two-dimensional image data acquired in different depth positions (focal positions) will be described.

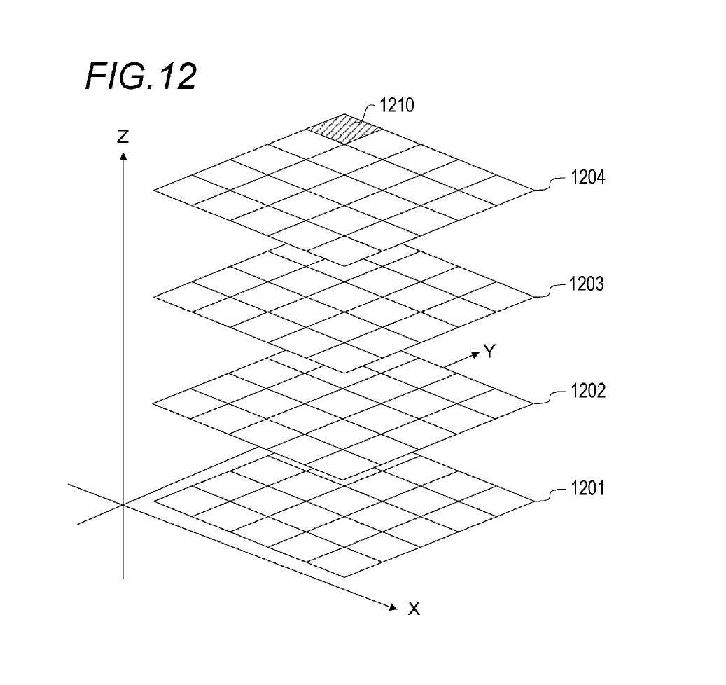

FIG. 12 is a schematic diagram depicting hierarchical image data having a hierarchical image structure, where two-dimensional image data which has a horizontal (X) direction and a vertical (Y) direction are arranged in the depth (Z) direction. The image data in FIG. 12 is constituted by sub-blocks having a size indicated by the reference number 1210, and has a Z stack image for each sub-block.

If movement in the horizontal direction and movement in the depth direction are possible as a change operation that the user can performed for the hierarchical image data having this structure, pre-read corresponding to these two change operations are performed. In concrete terms, two area groups: a horizontal (XY) area group and a depth (Z) are group, are set. For example, if an image of a partial area of the layer image group 1203 is displayed on the image display application, the layer image group 1203 is classified into the horizontal (XY) area group, and the layer image groups 1204, 1202 and 1201 are classified into the depth (Z) area group.

According to this embodiment, in the hierarchical image data in FIG. 12, the image data is compressed and encoded with the Z stack image in the sub-block unit. For the compression and encoding method, various methods can be used. For example, well known still image compression and encoding methods, such as JPEG, JPEG 2000 and JPEG-XR, can be used.

The compression and encoding may be applied for each Z stack image, where a plurality of sub-blocks in the same horizontal (XY) positions are stacked in the depth (Z) direction. In this case, video compression and encoding methods, such as MPEG, can be used, and compression and encoding may also be performed using a three-dimensional frequency operation, such as DFT (Discrete Fourier Transform), DCT (Discrete Cosine Transform) and DWT (Discrete Wavelet Transform). Images in the depth (Z) direction are highly similar, so the size of the hierarchical image data can be decreased by compressing and encoding in units of the Z stack image of the sub-block.

In the case of decoding data compressed and encoded in Z stack image units, it is preferable to read three-dimensional image data compressed and encoded in the memory area A, and decompress the image data corresponding to the pre-read area in the memory area B.

In the case of the hierarchical image data of this embodiment as well, image data in the magnification (M) direction can be generated by generating a reduced or enlarged image from each sub-block. For example, a reduced image can be easily created by extracting low frequency components from the compressed and encoded image data in the memory area A, and decoding the low frequency components and decompressing the image in the memory area B. JPEG 2000, for example, uses DWT which generates hierarchical image data by repeating the division in the low frequency side, hence the reduced image can be easily acquired. Therefore even if the hierarchical image data shown in FIG. 12 is used, the three area groups: horizontal (XY), depth (Z) and magnification (M), may be set, and pre-read according to each change operation may be executed. Zoom in/out and rotation display of the image can also be implemented using the same configuration as Embodiment 1.

In the case of the hierarchical image data of this embodiment as well, functional effects similar to Embodiment 1 to Embodiment 6 can be implemented by pre-reading (buffering) image data, and controlling allocation of the memory capacity using the same method as in each of these embodiments described above.

### Embodiment 8

In Embodiment 8, a case of using hierarchical image data constituted by a plurality of two-dimensional image data acquired at different magnifications (resolutions) will be described.

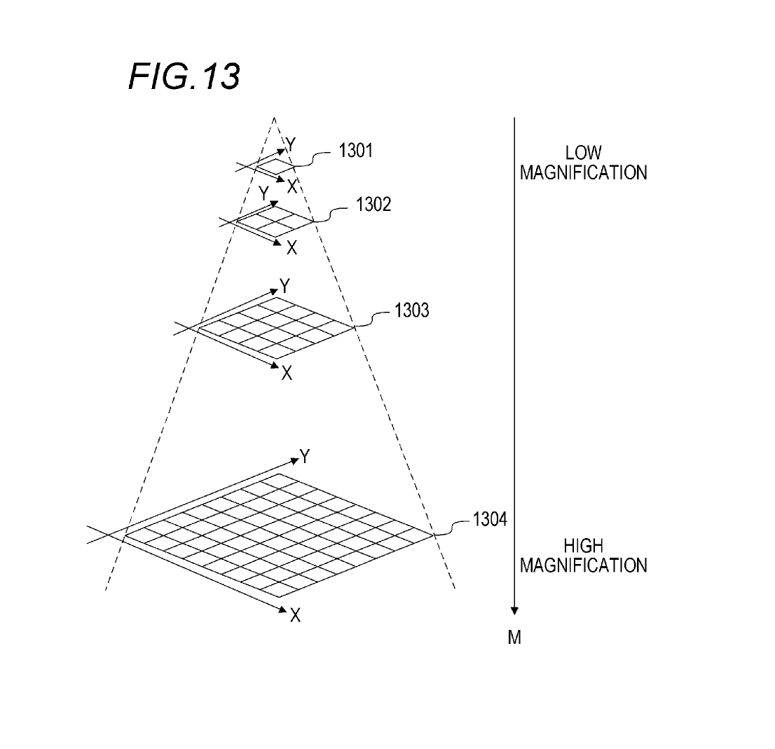

FIG. 13 is a schematic diagram depicting hierarchical image data having a hierarchical image structure, where two-dimensional image data which has a horizontal (X) direction and a vertical (Y) direction are arranged in the magnification (M) direction. The hierarchical image data in FIG. 13 is constituted by four two-dimensional image data indicated by 1301 to 1304. A range of the object that corresponds to one sub-block of the image data 1301 is a 2×2 block in the image data 1302, a 4×4 block in the image data 1303, and an 8×8 block in the image data 1304.

If movement in the horizontal direction and change of display magnification are possible as a change operation that the user can perform for the hierarchical image data having this structure, pre-read corresponding to these two change operations are performed. In concrete terms, two area groups: a horizontal (XY) area group and magnification (M) area group, are set. For example, if an image of a partial area of the block image group 1303 is displayed on the image display application, the block image group 1303 is classified into the horizontal (XY) area group, and the block image groups 1301, 1302 and 1304 are classified into the magnification (M) area group.

In the hierarchical image data in FIG. 13, a compression and encoding method, such as JPEG, JPEG-XR and JPEG 2000 can be used in sub-block image units. In this case, it is preferable to read the compressed and encoded image data in the memory area A, and decompress decoded image data in the memory area B.

In the case of hierarchical image data of this embodiment as well, functional effects similar to Embodiment 1 to Embodiment 6 can be implemented by pre-reading (buffering) image data and controlling allocation of the memory capacity using the same method as each of these embodiments described above.

In the examples shown in Embodiment 1 to Embodiment 8, each two-dimensional image data constituting the hierarchical image data consists of a plurality of blocks, as shown in FIG. 6, FIG. 12 and FIG. 13, but the present invention can also be applied to the case of a two-dimensional image data which is not divided into blocks. In this case, the size of the pre-read area may be determined not in block units but in pixel units, or when an image is displayed in the image display application, each two-dimensional image data may be divided into predetermined sized blocks in advance, and the same processing described in the above embodiments may be applied.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-31671, filed on Feb. 16, 2012, which is hereby incorporated by reference herein in its entirety.

### REFERENCE SIGNS

100: Image generating apparatus, 110: Operation input device, 120: Display, 130: Storage device, 302: Main memory

703: Pre-read area calculation unit, 704: Pre-read image data acquisition unit, 705: Display image decompression unit, 706: Display area acquisition unit

801: Hard disk, 802: Memory area A, 803: Memory area B

1-2. (canceled)

3. An image generating apparatus that generates display target image data from original image data for a viewer, which is configured to display an image corresponding to a portion of the original image data and to change the displayed portion of the original image data according to an operation by a user, the apparatus comprising:
a storage device configured to store original image data;
a buffer memory configured to temporarily store a portion of the original image data, wherein a data reading speed of the buffer memory is faster than a data reading speed of the storage device; and
a CPU coupled to the storage device and the buffer memory, wherein the CPU is programmed to function as:
a generation unit configured to generate the display target image data from the original image data according to the operation by the user, and to utilize, when data required for generating the display target image data is stored in the buffer memory, the data stored in the buffer memory; and
a control unit configured to predict data to be used by the generation unit and to control which portion of the original image data is to be stored in the buffer memory,
wherein the operation by the user includes a plurality of change operations, including: a first change operation to move a display target area in a horizontal direction and at least one of: a second change operation to move the display target area in a depth direction and a third change operation to change a display magnification,
wherein the control unit predicts data to be required for updating the display target image data for each of the plurality of change operations and stores the predicted data for each change operation in the buffer memory, and
wherein the control unit changes an allocation of data volume that can be stored in the buffer memory to each change operation, based on information, which includes:
information on a display magnification of an image currently displayed on the viewer;
annotation information attached to a region of interest in the original image data;
identification information of the user; or
information on a type of staining performed on an object in the original image data.

4. The image generating apparatus according to claim 3, wherein the control unit increases the allocation of the data volume to the first change operation as the display magnification is lowered.

5. (canceled)

6. An image generating apparatus that generates display target image data from original image data for a viewer, which is configured to display an image corresponding to a portion of the original image data and to change the displayed portion of the original image data according to an operation by a user, the apparatus comprising:
a storage device configured to store original image data;
a buffer memory configured to temporarily store a portion of the original image data, wherein a data reading speed of the buffer memory is faster than a data reading speed of the storage device; and
a CPU coupled to the storage device and the buffer memory, wherein the CPU is programmed to function as:
a generation unit configured to generate the display target image data from the original image data according to the operation by the user, and to utilize, when data required for generating the display target image data is stored in the buffer memory, the data stored in the buffer memory; and
a control unit configured to predict data to be used by the generation unit and to control which portion of the original image data is to be stored in the buffer memory,
wherein the operation by the user includes a plurality of change operations, including: a first change operation to move a display target area in a horizontal direction and at least one of: a second change operation to move the display target area in a depth direction and a third change operation to change a display magnification,
wherein the control unit predicts data to be required for updating the display target image data for each of the plurality of change operations and stores the predicted data for each change operation in the buffer memory,
wherein the control unit changes an allocation of data volume that can be stored in the buffer memory to each change operation, based on information, which includes a mode that the user sets in the viewer specifying a histological diagnosis mode or a cytological diagnosis mode, and
wherein the control unit increases the allocation of the data volume to the first change operation when the histological diagnosis mode is specified, more than in a case where the cytological diagnosis mode is specified.

7-8. (canceled)

9. The image generating apparatus according to claim 3, wherein the control unit increases the allocation of the data volume to the second or the third change operation, when the annotation information attached to an image currently displayed on the viewer, more than in a case where the annotation information is not attached.

10-12. (canceled)

13. The image generating apparatus according to claim 3, wherein the control unit determines, based on the information, whether the user is a user who performs a screening operation or a user who performs a detailed observation, and increases the allocation of the data volume to the first change operation, when the user is a user who performs a screening operation, more than in a case where the user is a user who performs a detailed observation.

14. (canceled)

15. The image generating apparatus according to claim 3, wherein the control unit determines, based on the type of staining performed on the object in the original image data, whether the original image data is data for a histological diagnosis or data for a cytological diagnosis, and increases the allocation of the data volume to the first change operation, when the original image data is data for a histological diagnosis, more than in a case where the original image data is data for a cytological diagnosis.

16. A method for controlling an image generating apparatus, the method comprising:
storing original image data in a storage device;
temporarily storing a portion of the original image data in a buffer memory, wherein a data reading speed of the buffer memory is faster than a data reading speed of the storage device;
generating display target image data from the original image data for a viewer configured to display an image corresponding to a portion of the original image data and to change the displayed portion of the original image data according to an operation by a user,
wherein the operation by the user includes a plurality of change operations, including: a first change operation to move a display target area in a horizontal direction and at least one of: a second change operation to move the display target area in a depth direction and a third change operation to change a display magnification;
utilizing, when data required for generating the display target image data is stored in the buffer memory, the data stored in the buffer memory;
changing an allocation of data volume that can be stored in the buffer memory to each change operation, based on information, which includes:
information on a display magnification of an image currently displayed on the viewer;
annotation information attached to a region of interest in the original image data;
identification information of the user; or
information on a type of staining performed on an object in the original image data;
predicting data to be required for updating the display target image data for each of the plurality of change operations; and
storing the predicted data for each change operation in the buffer memory based on the allocation of the data volume.

17. A non-transitory computer readable storage medium storing a program that when executed causes a computer to perform a control method of an image generating apparatus, the method comprising:
storing original image data in a storage device;
temporarily storing a portion of the original image data in a buffer memory, wherein a data reading speed of the buffer memory is faster than that of the a data reading speed of the storage device;
generating display target image data from the original image data for a viewer configured to display an image corresponding to a portion of the original image data and to change the displayed portion of the original image data according to an operation by a user,
wherein the operation by the user includes a plurality of change operations, including: a first change operation to move a display target area in a horizontal direction and at least one of: a second change operation to move the display target area in a depth direction and a third change operation to change a display magnification;
utilizing, when data required for generating the display target image data is stored in the buffer memory, the data stored in the buffer memory;
changing an allocation of data volume that can be stored in the buffer memory to each change operation, based on information, which includes:
information on a display magnification of an image currently displayed on the viewer;
annotation information attached to a region of interest in the original image data;
identification information of the user; or
information on a type of staining performed on an object in the original image data;
predicting data to be required for updating the display target image data for each of the plurality of change operations; and
storing the predicted data for each change operation in the buffer memory based on the allocation of the data volume.

18. A method for controlling an image generating apparatus, the method comprising:
storing original image data in a storage device;
temporarily storing a portion of the original image data in a buffer memory, wherein a data reading speed of the buffer memory is faster than a data reading speed of the storage device;
generating display target image data from the original image data for a viewer, which is configured to display an image corresponding to a portion of the original image data and to change the displayed portion of the original image data according to an operation by a user,
wherein the operation by the user includes a plurality of change operations, including: a first change operation to move a display target area in a horizontal direction and at least one of: a second change operation to move the display target area in a depth direction and a third change operation to change a display magnification;
utilizing, when data required for generating the display target image data is stored in the buffer memory, the data stored in the buffer memory;
changing an allocation of data volume that can be stored in the buffer memory to each change operation, based on information, which includes a mode that the user sets in the viewer specifying a histological diagnosis mode or a cytological diagnosis mode;
predicting data to be required for updating the display target image data for each of the plurality of change operations; and
storing the predicted data for each change operation in the buffer memory based on the allocation of the data volume,
wherein the allocation of the data volume to the first change operation is increased when the histological diagnosis mode is specified, more than in a case where the cytological diagnosis mode is specified.

19. A non-transitory computer readable storage medium storing a program that when executed causes a computer to perform a control method of an image generating apparatus, the method comprising:
storing original image data in a storage device;
temporarily storing a portion of the original image data in a buffer memory, wherein a data reading speed of the buffer memory is faster than a data reading speed of the storage device;
generating display target image data from the original image data for a viewer, which is configured to display an image corresponding to a portion of the original image data and to change the displayed portion of the original image data according to an operation by a user,
wherein the operation by the user includes a plurality of change operations, including: a first change operation to move a display target area in a horizontal direction and at least one of: a second change operation to move the display target area in a depth direction and a third change operation to change a display magnification;
utilizing, when data required for generating the display target image data is stored in the buffer memory, the data stored in the buffer memory;
changing an allocation of data volume that can be stored in the buffer memory to each change operation, based on information, which includes a mode that the user sets in the viewer specifying a histological diagnosis mode or a cytological diagnosis mode;
predicting data to be required for updating the display target image data for each of the plurality of change operations; and
storing the predicted data for each change operation in the buffer memory based on the allocation of the data volume,
wherein the allocation of the data volume to the first change operation is increased when the histological diagnosis mode is specified, more than in a case where the cytological diagnosis mode is specified.
